(19) United States
(12) Patent Application Publication
(10) Pub. No.: US 2006/0069576 A1
(43) Pub. Date: Mar. 30, 2006

(54) Method and system for identifying candidate colleges for prospective college students

(76) Inventors: Gregory L. Waldorf, Menlo Park, CA (US); Toby J. Waldorf, Los Angeles, CA (US); Gregory C. Ellis, Skillman, NJ (US)

Correspondence Address: LAW OFFICES OF MARK A. HAMILL, P.C., 45 SOUTH PARK BLVD., SUITE 205, GLEN ELLYN, IL, 60137, US

(21) Appl. No.: 10/951,452

(22) Filed: Sep. 28, 2004

(51) Int. Cl. G06Q 99/00

(52) U.S. Cl. 705/1

(57) ABSTRACT

The invention relates to the method for a prospective college student college search and recommendation system. The invention is generally includes a method of receiving survey data gathered from a prospective college student, analyzing the survey data for relationships between one or more variables which correlate with actual college student satisfaction with their college experience; and identifying one or more candidate colleges for the prospective college student to consider by determining an association between the prospective college student's survey data and candidate colleges.

### BACKGROUND

1. Field of the Invention

The invention relates generally to operation of a prospective student college selection search. More specifically, the invention relates to identifying one or more candidate colleges for a prospective student to consider attending based on analysis of empirical data which is predictive of the student's approximated satisfaction with attendance at one or more the identified schools.

2. Background of the Invention

Currently, college selection programs have been designed to assist students in selecting appropriate colleges to consider attending. These programs tend to consider a small number or factors, for example, the school's entrance requirements, academic programs offered, cost or geographic location. However, these matching techniques often do not account for the large number of variables that can determine whether a student's college experience is truly satisfying.

Empirical research conducted by the inventors has shown that a student's actual satisfaction with a college experience depends on complex interactions between a large number of variables which generally include, but are not limited to, budget constraints, academic qualifications, and the student's collegiate personality. The collegiate personality includes a number of social preference variables such as, the student's religious preferences, social opportunity preferences, style of learning preferences, preference for urban or rural environments, preference for geographical region, areas of academic interest, and extra-curricular interests. The large number of variables involved in determining satisfaction with a college experience has made past efforts to predict a student's satisfaction with a college experience less reliable than is desirable. As a result, there is a need for a method for prospective students to identify one or more colleges to consider attending which accounts for the complexity of the relationships between the variables that determine student satisfaction.

### SUMMARY OF THE INVENTION

The invention relates to the functions and operation of a prospective college student college search and recommendation system. The invention, embodied as a system and method, generally include receiving survey data gathered from a prospective college student, analyzing the survey data for relationships between one or more variables which correlate with actual college student satisfaction with their college experience; and identifying, with the computer, one or more candidate colleges for the prospective college student to consider by determining an association between the prospective college student's survey data and one or more of the variables which correlate with actual college student satisfaction with their college experience. The method may also include approximating the satisfaction that the prospective college student will have in attending one or more particular candidate colleges.

In one preferred method of the invention, a scoring tool is used to segment the prospective college student into one of a plurality of appropriate student collegiate personalities based on survey data gathered from the prospective student. Each of the collegiate personality segments has been derived from empirical data concerning college satisfaction drivers for a large sample of actual students. The segmentation of the prospective student into one of plurality of collegiate personality segments is generally accomplished with three levels of sub-segmentation. First, the student is macro-segmented by means of a collegiate personality scoring tool into either a budget constrained or not-constrained group. Per the inventor's empirical research data, this factor is one of the most important drivers of prospective student college choice and satisfaction. Next, the student is further segmented and assigned a collegiate personality based on his or her best fit between survey-based individual profile information and defined collegiate personality segments. These defined segments are preferably mutually exclusive collectively exhaustive (MECE) collegiate personality segments which reflect drivers of actual student college satisfaction for students sharing common personality traits. More generally each segment can be thought of as representing a certain personality type that is positively correlated with college student satisfaction at different types of colleges. The next level of segmentation is based on the student's academic achievement. The prospective student who has been segmented by collegiate personality is further segmented into a grouping by past academic achievement. At this point, it is preferred that the student is queried for regional location and other preferences. Assuming the student specifies preferences, the information can be used to limit the number of appropriate candidate colleges identified and provided to the prospective student. If the prospective student had no geographic preference, the student can be shown all of the appropriate college candidates. The appropriate candidate colleges are identified for the student by searching a collegiate personality/college database to find candidate colleges whose actual college satisfaction data strongly correlates with the prospective student's assigned collegiate personality/academic achievement segment. Preferably, for each prospective student user the system also includes a determination of an approximated college satisfaction score for the identified candidate colleges as well as rank for each of them as to probability of admission (e.g., as safety, target, or reach candidates) based upon the academic qualifications of the prospective student and admission standards of candidate colleges. The determination is made based upon a comparison of the student's academic achievement with the college's historical admission data concerning similarly qualified students.

In accordance with one particularly preferred embodiment of the method, the database of matching colleges and collegiate personalities is generated by utilizing the qualitative summaries of the empirical data to provide one or more expert college counselors with defined segments to match with appropriate candidate colleges. The expert(s) base each match for each collegiate personality/college match upon their research and experience into the college environment at each candidate college for each segment. Optionally, the resultant collegiate personality/candidate college database can be compared to the empirical actual college satisfaction data to provide an empirical check on the contents of the database to ensure that appropriate colleges were included or inappropriate candidate colleges excluded.

In anther preferred method of the invention, the collegiate personality/college database is generated primarily through correlating the empirical college satisfaction data for each actual collegiate personality segments with a list of appropriate candidate colleges. These lists are then reviewed by an expert in college placement to ensure that the correlations from the database are consistent with the expert's real world experience. In this preferred method of the invention, any correlations between collegiate personality profile and college satisfaction which the expert feels is tenuous or erroneous can be removed the database. This expert clean up function is preferred since it can weed out the effects of “terminally satisfied students,” that is, those students that show no strong preference concerning common satisfaction drivers on their surveys. Such students appear to be happy at any college, and thus, their college data is not helpful in identifying college satisfaction drivers and assigning students to their best fit colleges. The expert clean up function ensures that the final recommendation set of colleges for the prospective student is not overly inclusive due to the effect of data from terminally satisfied students. Whether either of the these alternate methods of generating a collegiate personality/college recommendation set is utilized, the resultant collegiate personality college recommendation set, in accordance with these preferred embodiments of the invention, combines rigorous analysis of empirical data with expert college counselor input and expertise.

Optionally, at this point, in a real time embodiment of the method of the invention, a written personality description can be displayed to the prospective student to assure that the student generally agrees with the segmentation proposed by the scoring tool. The student can also be asked to review survey answers he or she gave to correct any erroneous answers that may lead to a less than satisfactory personality description. Preferably, the prospective college student is further queried about any further choice narrowing preferences for colleges that he or she may have. Assuming the prospective student has such preferences, the college recommendation set can be further limited by removing from the candidate college list candidate colleges which fall outside the prospective student's selected choice limiting preferences. In any event, the college recommendation set is displayed to the prospective student, preferably in real time.

The methods of the invention also include collecting data from a survey completed by each of a representative sample of actual college students attending each of a plurality of colleges. Each survey includes a plurality of inquiries into matters that are relevant to the student's actual satisfaction with his or her college experience. Preferably, at least a portion of the inquiries have answers that are associated with a numerical scale. The method also includes analyzing the answers which the actual students provide for actual college satisfaction drivers. From the analysis, a plurality of college student personality segments can be generated based on budget constraints, internal motivators, environmental motivators, and academic motivators. Resultant college student personality segments can be used to develop a collegiate personality scoring tool. Resultant collegiate personality scoring tool can be applied to a larger sample of college students to yield projected collegiate personality segments with a large sample of colleges reflected within each. In one preferred method of the invention, the discrete categories of personality profiles define at least thirty mutually exclusive collectively exhaustive (MECE) segments of student college choice drivers. The scoring tool is used to place a student into the correct MECE segment and to quantify an approximate satisfaction score. These segments and scores are then matched within the database to identify similarly segmented students with correlated actual satisfaction scores. From the segmentation data, comprehensive student personality profiles are generated based on the segmentation of the students. This profile includes a written qualitative description of the college satisfaction and/or personality traits for the prospective student based on his assigned collegiate personality segment and individual response data.

Alternately, a factor analysis to identify a plurality of factors which correlate with student satisfaction with particular groups of colleges can be performed. These factors may then be used to generate discrete categories of collegiate personality profiles and correlate those profiles with one or more colleges. One embodiment of the invention also includes identifying the factors that most highly predict satisfaction in a prospective student's college experience. This method includes the steps of analyzing a student's budgetary constraints, analyzing a student's academic achievement, and analyzing the student's collegiate personality profile and correlating the results of the three analyses with empirical satisfaction data of actual college students. Still another embodiment of the invention includes inputting into a computer network information provided by a prospective college student and receiving from the computer network a list of one or more candidate colleges that the computer network has determined will provide a satisfying college experience. Yet another embodiment of the invention includes identifying appropriate candidate colleges and providing one or more communication links with the candidate college so that the student can further investigate and communicate with the candidate colleges. The communication link may be interactive with the college admissions department of the candidate college and may also be used to gather information concerning the application process for the candidate colleges.

A still further embodiment of the invention includes a method for identifying to a prospective student candidate post secondary schools, such as a graduate school or vocational school, by applying the survey and segmentation methods described above for candidate colleges to such post secondary schools.

### BRIEF DESCRIPTION OF THE DRAWINGS

FIG. 1 illustrates a system for matching a prospective college student with one or more candidate colleges selected from among a pool of candidate colleges.

FIG. 2 illustrates an example of a survey that is answered by numerous college students and prospective college students.

FIG. 3 illustrates the structure and contents of an empirical database generated from the answers to the survey illustrated in FIG. 2.

FIG. 4 is an example of a correlation matrix that shows the degrees of correlation between actual student personality data, satisfaction data and candidate colleges in the empirical database.

FIG. 5 illustrates factors as a function of the answers to one or more inquiries on a survey.

FIG. 6 illustrates the structure and contents of a factor value database that lists the value of the factors for particular actual student satisfaction.

FIG. 7 illustrates a linear regression performed on actual student satisfaction index data plotted versus the value of a particular factor for a college candidate listed in the factor value database.

FIG. 8 illustrates an example of a prospective student/college database which lists the difference in the value of particular factors between the prospective student and satisfaction values for a candidate college.

FIG. 9 illustrates an individual satisfaction index plotted versus the value of the differential factor labeled .DELTA.F.sub.1

FIG. 10 illustrates the invention embodied as a method of operating a prospective student college selection service.

FIG. 11 illustrates the invention embodied as a method of preparing empirical data in preparation for selecting appropriate candidate colleges by a prospective student. FIG. 12 illustrates the invention embodied as a method for using the prepared empirical data to select one or more candidate colleges for a prospective student.

FIG. 12 illustrates the invention embodied as a method of selecting appropriate candidate colleges by a prospective student as a method for using the prepared empirical data to select one or more candidate colleges for a prospective student.

FIG. 13 illustrates a supervised backpropogated neural network.

FIG. 14 includes sample survey questions in accordance with one preferred method of the invention.

FIG. 15 includes sample survey questions in accordance with one preferred method of the invention.

FIG. 16 is a sample page from a database recording analysis of actual student survey answer and assigning segmentation value thereto in accordance with one preferred method of the invention.

FIG. 17 is a schematic representation of a number of sample actual student segments and the variables which help define each segment.

FIG. 18 is also schematic representation of a number of sample actual student segments and the variables which help define each segment.

FIG. 19 is graphic representation of a summary of an analysis of the prospective student's survey results which are also known as a customized U-Factor personality profile.

FIG. 20 is a written description of a sample U-Factor personality profile for a prospective student.

FIG. 21A is a portion of a comprehensive student collegiate personality/college match database.

FIG. 21B is another portion of the comprehensive student collegiate personality/college match database.

### DETAILED DESCRIPTION

The invention relates to the functions and operation of a college selection service. The selection service employs empirical data to identify and select one or more candidate colleges for a prospective college student to consider for matriculation. In accordance with one preferred embodiment of the invention, when the prospective student wishes to communicate with the selected candidate colleges, the search service allows them to communicate at a plurality of communication levels. Each of the communication levels allows the prospective student and candidate colleges to exchange information in different formats. Examples of exchanging information at different communication levels include the candidate college students providing answers to questions provided by the selection service, providing items selected from a list provided by the selection service such as brochures, applications, financial aid forms, providing links to informational web sites for the candidate colleges or providing addresses for addressing e-mail communications to appropriate persons within the admission office of the candidate colleges.

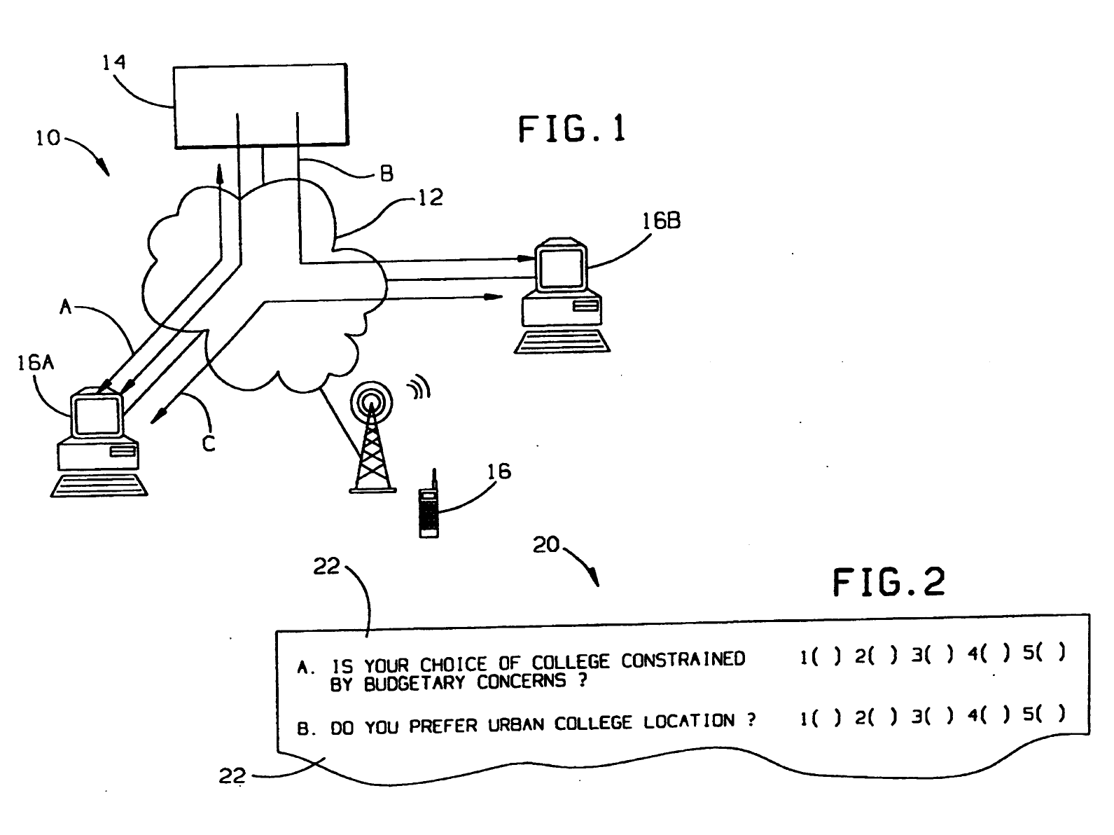

The identification and selection of particular candidate colleges for the prospective student to consider is based on empirical data gathered from actual college students that have attended the candidate colleges. The selection service gathers, organizes and correlates the empirical data for use in identifying appropriate candidate colleges from the large number of colleges in the database. In accordance with embodiments of the invention illustrated in FIG. 1-13, the data preparation can include generation of an actual student/candidate college satisfaction estimator. The prospective student/candidate college satisfaction estimators are used to select a discrete number of “Best Fit” candidate colleges for a student to consider. The prospective student of the college selection service completes a survey to provide data to the selection service. The prospective student's data is compared to actual student data to approximate the satisfaction the prospective student will have in his/her potential college experience. Candidate colleges for selection by the prospective student are identified based on the satisfaction experienced at those colleges by real college students most similar to the prospective student users of the service. For instance, identifying candidate colleges which have high actual student satisfaction results for students who are similar to the prospective students reduces the chances of the student selecting an inappropriate college to attend. Improved prospective student/candidate college matching should improve student satisfaction with their college experience and should reduce college drop out rates. A unique set of the identified candidate college is then selected as a custom recommendation set for each prospective student user. Data for the prospective student and data for actual students that attended the selected candidate college is compared to approximate the satisfaction that the prospective student would have if attending that candidate college. This is repeated for each of each of the prospective student users of the service. The results are studied to identify the candidate college and prospective student combination that would result in the most satisfaction. The prospective student is then given the option of communicating with one of more of the identified candidate colleges.

As described above, the approximate prospective student satisfaction index and the prospective student/candidate college satisfaction index are generated from empirical data. The empirical data is generated from surveys completed by a large number of actual students attending each of the candidate colleges. Each survey includes a plurality of inquiries into matters which are relevant to each student in having a satisfying college experience. The inquiries can have numerical answers. In the embodiments of the invention illustrated in FIGS. 1-13, these answers are used in a factor analysis to identify factors that are each a function of one or more correlated inquiries. These factors are used in the identification of the prospective student collegiate personality and the prospective student/candidate college recommendation set. Because the factors are a function of several inquiries, the use of the factors reduces the number of variables considered when generating the prospective student collegiate personality and the student/candidate college recommendation set. However, the complexity of the relationships between the variables (question answers) is retained in the results because each of the variables is taken into consideration when generating the factors.

In one embodiment of the invention, a college selection service uses the methods taught in this specification to train a neural network. Training the neural network allows the selection service to take advantage of a neural network's ability to resolve problems in the presence of noisy and complex data. Additionally, the selection service can take advantage of the neural network to learn to improve the quality of the matching results. However, it is also contemplated that the service of the invention may be programmed into and operated in a suitable general purpose computer having a single CPU.

FIG. 1 illustrates an embodiment of a system 10 for a prospective student to select one or more appropriate college candidates to consider attending. The system 10 includes a network 12 providing communication between a selection service 14 and one or more remote units 16. The selection service 14 can include one or more processing units for communicating with the remote units 16. The processing units include electronics for performing the methods and functions described in this application. In one embodiment, the processing units include a neural network. Suitable remote units 16 include, but are not limited to, desktop personal computer, workstation, telephone, cellular telephone, personal digital assistant (PDA), laptop, or any other device capable of interfacing with a communications network. Suitable networks 12 for communication between the server and the remote units 16 include, but are not limited to, the Internet, an intranet, an extranet, a virtual private network (VPN) and non-TCP/IP based networks 12.

A prospective student of a remote unit 16 and the selection service 14 can communicate as shown by the arrow labeled A. Examples of communications include exchange of electronic mail, web pages and answers to inquiries on web pages. The prospective college student of the remote unit 16a can also communicate with the candidate college remote unit 16b as indicated by the arrow labeled B. The selection service provides the communication by receiving the communication from the prospective student and providing the communication to the candidate college. The prospective student can also elect to communicate directly with a candidate college as shown by the arrow labeled C.

The selection service 14 employs a data preparation stage, a selection stage and may optionally include a communications stage. During the data preparation stage, empirical data is manipulated in preparation for the selection stage. The empirical data is used to select one or more candidate colleges for the prospective college student in the selection stage. At the communication stage, communication can be achieved between the prospective student and one or more of the candidate colleges. The communication can occur in one or more communication stages which are selected by the prospective student and the candidate colleges.

The selection service 14 employs empirical data during the data preparation stage. The empirical data is generated from answers to surveys such as the survey 20 illustrated in FIG. 2. The survey 20 asks a series of inquiries 22 that can be numerically answered. For instance, the inquiry “Is your choice of college constrained by budgetary concerns” is followed by a series of numbers arranged in a scale. The prospective student provides an answer somewhere along the scale based on their preference for the activity. For instance, a “1” can indicate that the student has no budgetary constraints while a “7” indicates that the student has serious budget constraints. Because the answer to each question varies from prospective student to prospective student, each inquiry and the associated answers are often referred to as variables.

Surveys 20 can be completed for the purpose of generating enough data for the selection service to make reliable selections of candidate colleges for prospective students. For instance, a large number of students can be enlisted to fill out the surveys 20. These answers can then be used to construct an empirical database that can be used in the method of selecting candidate colleges for prospective students. However, the actual students who fill out these surveys need not become clients of the selection service. As will become more apparent from the following discussion, the empirical database preferably should include data from large number of actual students that are highly satisfied with their college experience. The applicants have found that a database containing survey results from about fifteen thousand actual college students should be more than adequate to provide reliable selection results.

The survey 20 is preferably completed by means of a remote unit 16 with access to the selection service 14. The survey can be made available to the prospective student in the form of one or more web pages after the prospective student has registered for use of the selection service. After submitting the completed survey to the selection service, the prospective student can request a list of candidate colleges from the selection service. The prospective student can also request to become a candidate to receive information concerning additional non-selected colleges. In either case, the survey answers provided by the selection service are stored in the empirical database.

The survey and/or the registration process can also request that the prospective student submit communication preferences and contact information. This information can indicate whether the prospective student authorizes the selection service to contact the candidate college on his or her behalf to request information, application or forms or provide his contact information for contact by the candidate college admission office. The information which is provided can be entirely up to the prospective student. The survey and/or the registration process can also request information to categorize the prospective student to assist in the candidate college selection process. For instance, prospective student seeking candidate colleges having a specific religious affiliation, location, tuition range or academic requirements are easy to categorize and thereby limited the scope of the search. The survey 20 need not be constant and can change with time. For instance, as the selection service 14 finds that certain inquiries 22 are less effective at revealing college experience satisfaction, these inquiries 22 can be dropped from the survey 20. Additionally, the selection service can add new questions to the survey to find out whether the new questions add insight into college experience satisfaction.

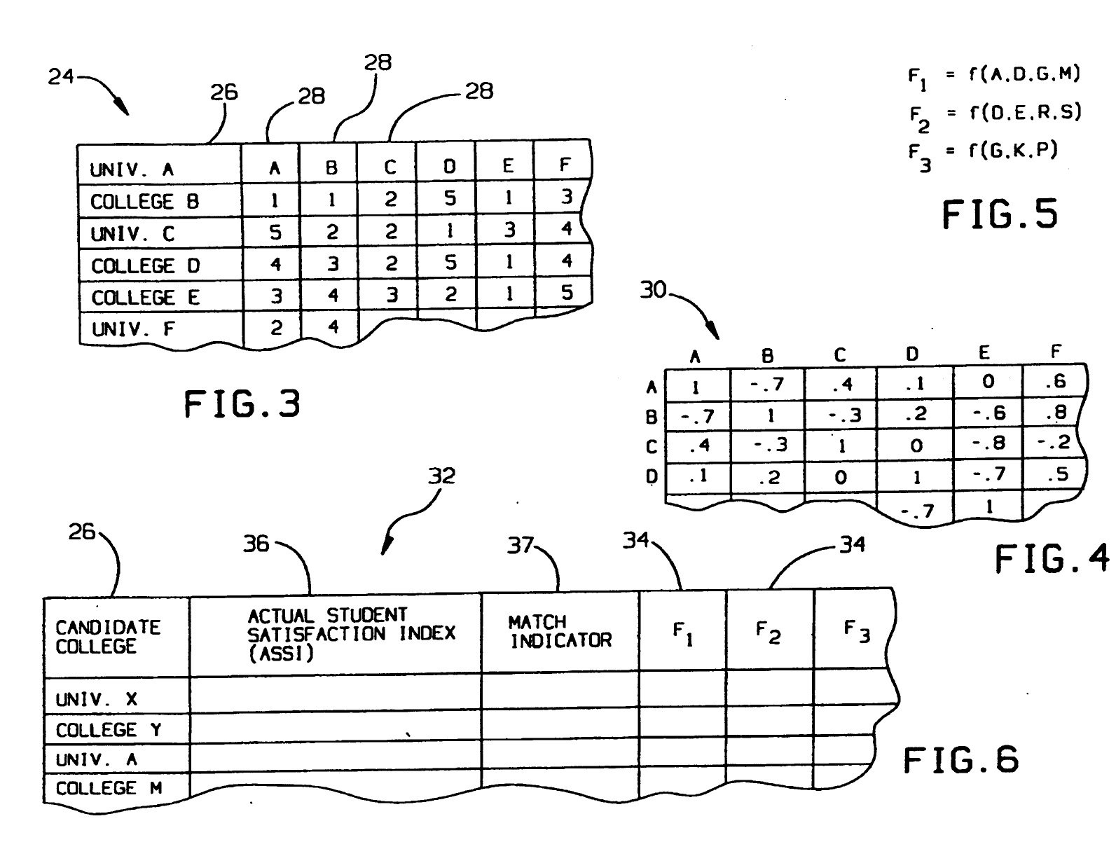

As described above, the answers to the survey 20 are used to generate an empirical database. FIG. 3 is an example of an empirical database 24. The empirical database 24 may include a column of identifier fields 26 that correspond to each candidate college for which students have filled out a survey 20. Example identifiers include the candidate college's name or other symbol associated with a particular college. The empirical database 24 will include a plurality of variable columns 28. Each variable column 28 is preferably marked by a particular letter that is associated with an aggregate for one of the inquiries 22 of satisfied students at the candidate college discussed above. Each field in a variable column 28 indicates an aggregate of actual satisfied student's answers to an inquiry in the survey 20. Fields in the empirical database 24 can also be empty as results when certain inquiries 22 are dropped or added to the survey 20. Empty fields can also result when a prospective student chooses not to answer one or more of the inquiries 22.

The survey should include at a minimum whether the student has budgetary constraints or not; whether the student's academic qualifications fall into low, medium or high categories; and at least some indicators of the student's collegiate personality. The collegiate personality profile is assessed by surveying for an array of student preferences concerning a variety of qualities in a college, which may include geographic location, academic program, urban versus rural campus preference, campus size, abundance of social opportunities, politics (e.g., liberal versus conservative), structured versus unstructured academic environment, independent versus supportive environment and religious affiliation. The combination of these three classes of variable, budget, academic qualifications, and collegiate personality, have been found to be strongly predictive of actual student satisfaction at an individual college.

A correlation matrix 30 is constructed from the empirical database 24 in order to illustrate the degree of correlation between the variables of the empirical database 24. An example of a correlation matrix 30 is illustrated in FIG. 4. Each field of the correlation matrix 30 shows the degree of correlation between two of the variables. The degree of correlation can vary from negative one to positive one. A value of one indicates a high degree of correlation between the two variables. As a result, the correlation between variable A and itself is 1. The correlation matrix 30 is constructed from the empirical database 24. A suitable program for generating the correlation matrix 30 is STATISTICA from Statsoft, Inc. of Tulsa Okla. The variables used to construct the correlation matrix 30 are selected from the variables in the empirical database 24 by the selection service 14. As a result, variables that are proven to be less relevant to the satisfaction of a student can be removed from the correlation matrix 30.

The correlation matrix 30 is examined to identify combinations of correlated variables that are commonly called factors. The factors are identified in a statistical process known as factor analysis. Factor analysis is a method of combining multiple variables into a single factor in order to reduce the total number of variables that must be considered. Hence, each factor is a function of one or more variables as illustrated in FIG. 5. For instance, the factors can be a weighted linear combination of two or more variables. The factor analysis is preferably performed to identify the minimum number of factors which are needed to account for the maximum percentage of the total variance present in the original set of variables. A suitable factor analysis includes, but is not limited to, a principle component analysis with an eigenvalues greater than or equal to 1 criteria and a rotational procedure that is the biquartimax solution.

The factors are then used to generate a factor value database 32 such as the database illustrated in FIG. 6. The factor value database 32 can include a column of identifier fields 26 and several columns of factor fields 34. Each field in a column of factor fields 34 lists the value of a factor for a particular candidate college. The candidate college listed in the factor value database may include different candidate colleges and students than the empirical database. For instance, as data in the empirical database becomes outdated it can be dropped from the factor value database. The factor value database 32 also includes a column of the actual student's satisfaction index fields 36 for individual candidate colleges. The student satisfaction index indicates the level of satisfaction that a particular prospective student may have in an unspecified college experience.

An individual student satisfaction index can be generated from students that are past clients of the college selection service 14. For instance, each student client could be sent follow up surveys 20 at various times after enrolling in the selected candidate college in order to determine each student's actual level of satisfaction with the selection. The answers to these surveys 20 could then be used to determine an individual satisfaction index. A selected college index based on results of selection services 14 selection provides feedback concerning match results. Updating the methods of the present invention with this feedback can allows the selection service to “learn” by taking into account the results of previous selection when making prospective selection. Other student selection indexes can also be constructed for use with the methods of the present invention.

Individual satisfaction indexes determined by different methods can be scaled so they can be compared. Accordingly, an individual satisfaction index generated from selection results can be compared with a standardized measure. Accordingly, the selection service 14 can convert a standardized measure based individual satisfaction index to an individual satisfaction index derived from the selection results.

The factor value database 32 is used to approximate relationships between the individual satisfaction index and one or more of the factors. This relationship is called an individual satisfaction estimator because the relationship can be used to approximate an individual satisfaction index for an individual as will be described in more detail below.

An individual satisfaction estimator can be determined for each of a plurality of mutually exclusive collectively exhaustive collegiate segments (MECE segments). A MECE segment is a grouping of actual college students that attended candidate colleges who have similar factors which strongly correlate with their satisfaction with their college experiences. For instance, suitable MECE segments may include students described as Non-Budget Constrained Focused Supportive Sciences Major or as Budget Constrained Focused Supportive Other Major. Preferably, a prospective student that survey results indicate a strong preference for factors correlated with a MECE segment will have a selection generated using only the data for colleges that correlates with the satisfaction of the students within the particular MECE segment.

A suitable method for approximating a relationship between the individual satisfaction index and one or more of the factors includes, but is not limited to, performing a multiple linear regression and correlation analysis on the individual satisfaction indexes versus the factor data. Software for performing the multiple linear regression and correlation analysis is available from STATISTICA from Statsoft, Inc. of Tulsa Okla. The linear regression is preferably a step-wise linear regression.

Multiple linear regression and correlation analysis is a preferred method for approximating the relationship because the differential factors that are minimally correlated to the selection satisfaction index can be removed from the relationship. Accordingly, the number of factors included in the relationship is reduced. The factors included in the relationship are called selected satisfaction factors below.

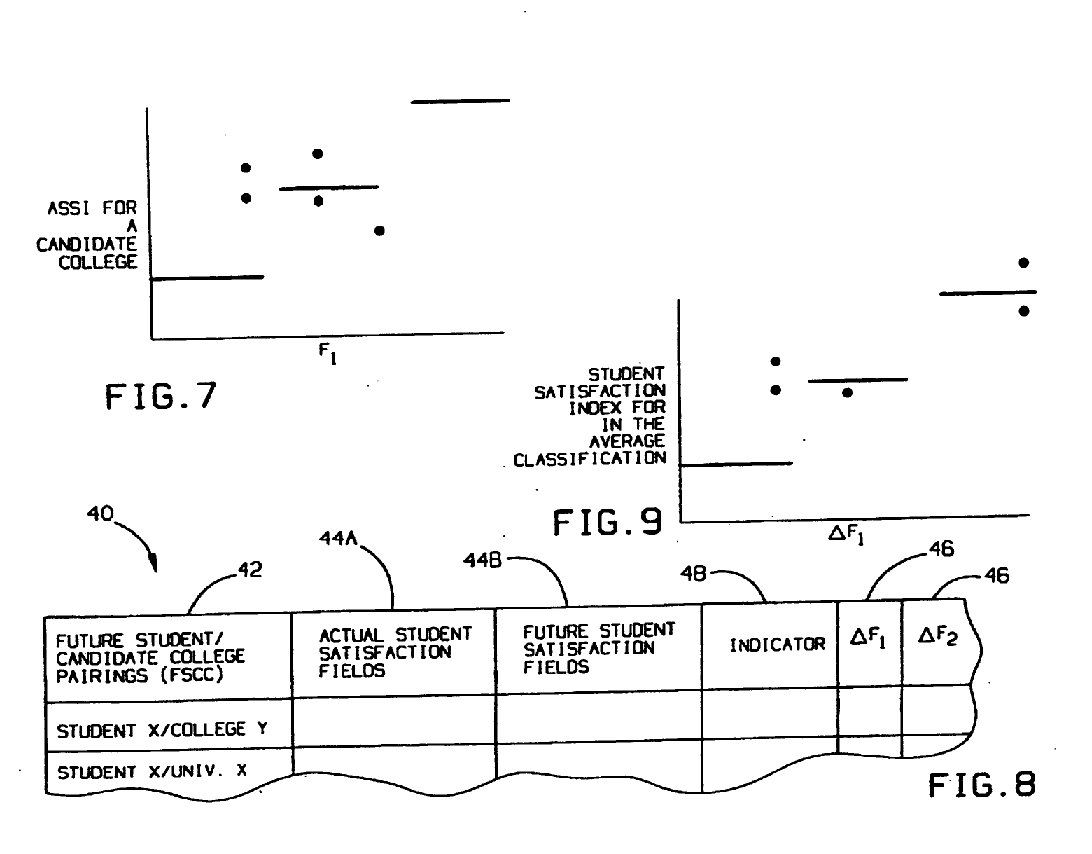

FIG. 7 illustrates an example of generating a relationship between the student satisfaction index and one of the factors. For the purposes of illustration, the example is highly simplified to include a single factor. The individual satisfaction indexes for actual students attending the candidate colleges are plotted versus the value of a factor labeled F.sub.1. The results of a step-wise linear regression performed on the plotted data is illustrated. These results are the approximated relationship between the student satisfaction index and the factor value.

Equation 1 is an example of an individual satisfaction estimator generated using a multiple linear regression and correlation analysis. This analysis is performed by the computer software generally referred to herein as a scoring tool. Each of the selected satisfaction factors is assigned a weight according to the degree of correlation between the value of the factor and the individual satisfaction index. The higher the degree of correlation associated with a particular factor, the higher the weight assigned to that factor. The selected satisfaction factors are combined as shown in Equation 1 where C is the approximated individual satisfaction index, F.sub.i is a selected satisfaction factor i and w.sub.i is the weight assigned to F.sub.i.
C=.SIGMA.w.sub.i F.sub.i Equation 1

A prospective student/candidate college (PSCC) database 40 can also be generated from the factor value database 32. FIG. 8 illustrates an example of a PSCC database 40. The PSCC database 40 includes a column of prospective student/candidate college identifier fields 42, column of student individual satisfaction index fields 44A, column of collegiate satisfaction index fields 44B and several columns of differential factor fields. The fields in the column of student satisfaction indexes list the individual satisfaction index for the student in PSCC match and the fields in the column of collegiate satisfaction indexes list the aggregate satisfaction index for actual students of each college of a PSCC match. The fields in the columns of differential factor fields list the difference between the values of a factor for the PSCC match. For instance, the fields in the column of differential factor fields 46 labeled .DELTA.F.sub.1 can the list difference between the value of F.sub.1 for the candidate college of a PSCC match and the value of F.sub.1 for the prospective student of the PSCC match.

The PSCC database 40 can be used to approximate relationships between the prospective student satisfaction index and one or more of the differential factors. This relationship is called a PSCC satisfaction estimator because it can be used to approximate the satisfaction that a prospective student would have in attending a particular candidate college. A PSCC estimator can be determined for each class that a student is placed into based on their individual student satisfaction index or their approximate individual satisfaction index. A PSCC satisfaction estimator for a particular class is generated using only data for members of the class.

A suitable method for approximating a relationship between the prospective student satisfaction index and the one or more of the differential factors includes, but is not limited to, performing a multiple linear regression and correlation analysis on the prospective student satisfaction index versus the differential factor data. Software for performing the multiple linear regression and correlation analysis is available from STATISTICA from Statsoft, Inc. of Tulsa Okla. The linear regression is preferably a step-wise linear regression.

Multiple linear regression and correlation analysis is a preferred method for approximating the relationship because the differential factors that are minimally correlated to the PSCC satisfaction index can be removed from the relationship. Accordingly, the number of differential factors included in the relationship can be reduced. The factors included in the relationship are called selected differential factors below.

FIG. 9 illustrates an example of generating a relationship between the prospective student satisfaction index and one of the differential factors. For the purposes of illustration, the example is highly simplified to include a single differential factor. The actual student satisfaction indexes for students in the average classification are plotted versus the value of a differential factor labeled .DELTA.F.sub.1. The results of a step-wise linear regression performed on the plotted data is illustrated. These results are the approximated relationship between the actual student satisfaction index and the differential factor for students in the average class. Equation 2 is an example of a PSCC satisfaction estimator generated using a multiple linear regression and correlation analysis. Each of the selected differential factors is assigned a weight according to the degree of correlation between the value of the differential factor and the student satisfaction index. The higher the degree of correlation associated with a particular differential factor, the higher the weight assigned to that differential factor. The selected differential factors are combined as shown in Equation 2 where CI is the approximate PSCC satisfaction index, F.sub.i is a selected satisfaction factor i and w.sub.i is the weight assigned to F.sub.i.
CI=.SIGMA.w.sub.i.DELTA.F.sub.i Equation 2.

As described above, the PSCC satisfaction estimator can be used to determine an approximate satisfaction index for a PSCC match. The approximate PSCC satisfaction index is determined by comparing the PSCC's survey answers to the PSCC satisfaction estimator. For instance, the PSCC's answers can be used to calculate each of the selected differential factors in Equation 2. Each of these differential factors is substituted into Equation 2 along with the appropriate weights to determine the approximate satisfaction index, CI. The approximate PSCC satisfaction index is an approximate value of the satisfaction index that a particular student would have in a college experience at each individual candidate college.

During the identification stage, the identification system 10 matches a prospective student operating a remote unit 16 with one or more candidate colleges. The prospective student fills out a survey 20 at the remote unit 16. In one embodiment, the survey 20 includes only the variables needed to calculate each of the selected factors and the selected differential factors. In another embodiment, the survey 20 includes the variables needed to calculate each of the factors identified during the factor analysis. In yet another embodiment, the survey 20 includes more variables than are needed to calculate the factors identified during the factor analysis.

The selection service 14 receives the survey 20 filled out by the prospective student and the student's identified college candidate group is identified. The student satisfaction estimator associated with the identified college candidate group is identified. The student's answers to the inquiries 22 are compared to the identified student satisfaction estimator to determine an approximate student satisfaction index for the student.

The selection service 14 then selects candidate colleges to be matched with the student. The selected candidate colleges have actual student aggregate survey results that fall within either the same or similar class as the prospective student. Alternatively, the actual student aggregate of the candidate college fall within a class or classes that are similar to the student. For instance, if the student has high academic qualifications and fits within the good student classification, the college candidate college falls within academically selective category with aggregate student survey results of the good student classification.

The selection service identifies the PSCC satisfaction estimator associated with the student's classification and one of the identified college candidates is selected. The student's answers to the inquiries 22 and the selected candidate college's actual student aggregate answers to the questions are compared to the PSCC satisfaction estimator to determine an approximate PSCC satisfaction index for the prospective student and the selected candidate college. As discussed above, the approximate PSCC satisfaction index approximates the satisfaction that the student will have in attending a selected candidate college. An approximate PSCC satisfaction index is generated for each identified candidate college.

The selection service uses the approximate PSCC satisfaction index to identify potential matches for the student. For instance, the student service can select candidates who result in a PSCC satisfaction index over a particular threshold as potential matches. Alternatively, some pre-determined number of candidates resulting in the highest PSCC satisfaction indexes may be identified as potential match candidates.

Additionally, the selection service can use a criteria based on determining a PSCC satisfaction index for each student/candidate college combination. For instance, for each PSCC combination, the selection service can identify the PSCC satisfaction predictor associated with the estimated collegiate personality of the student and each candidate college to be considered. The survey answers for the student and the aggregate of students for the candidate college can be compared to the PSCC satisfaction predictor associated with the collegiate personality of the prospective student to generate an approximate PSCC satisfaction index for the student and each candidate college. Accordingly, the selection service will have approximated the student's satisfaction in attending each alternative candidate college.

During the optional communication stage, the selection service 14 may provide relevant information for each of the candidate colleges to the prospective student. The selection service 14 can also provide the student with several communication levels from which to choose. Each of the communication levels allows the parties to exchange information in a different format. Examples of exchanging information at different communication levels may include providing (a) items selected from a list provided by the selection service such as brochures, applications, financial aid forms, (b) links to informative web sites for the candidate colleges, or (c) addresses for addressing e-mail communications to appropriate persons within the admission office of the candidate colleges.

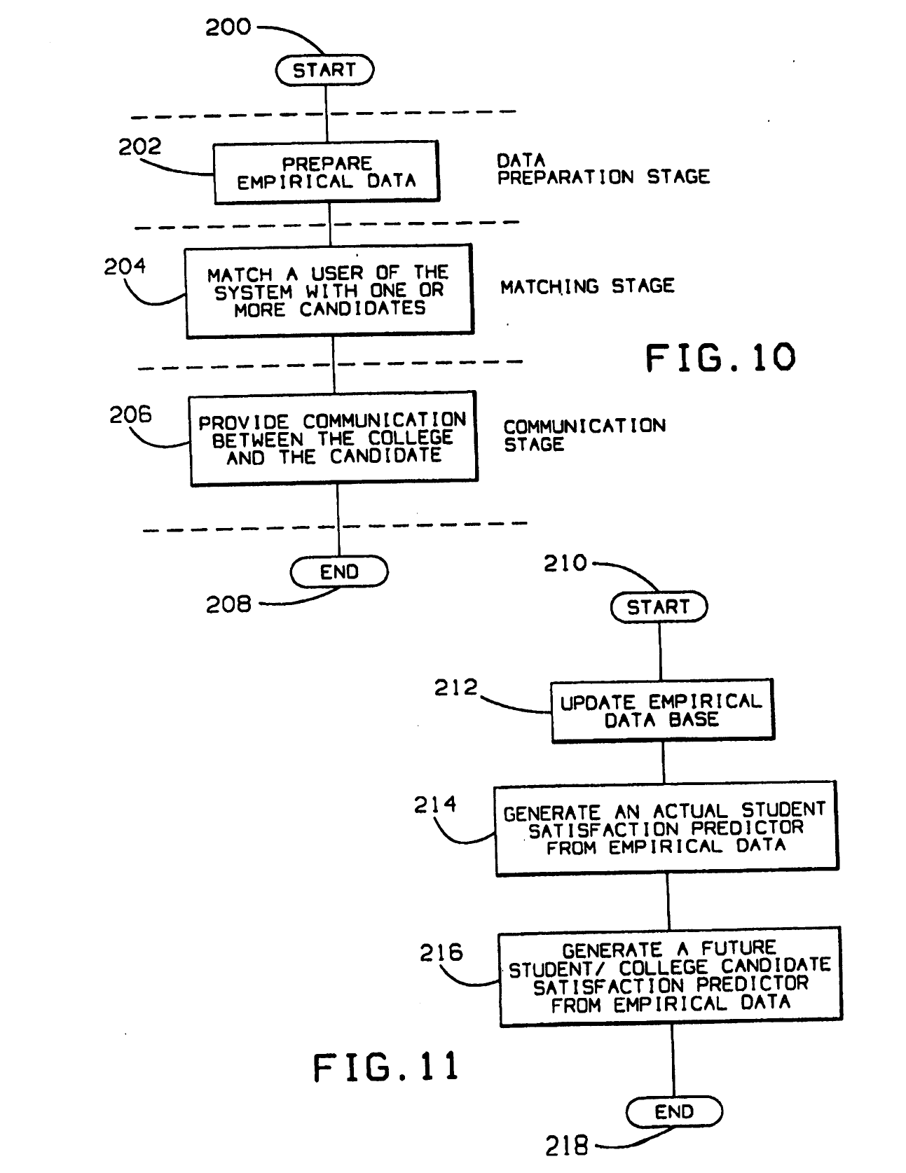

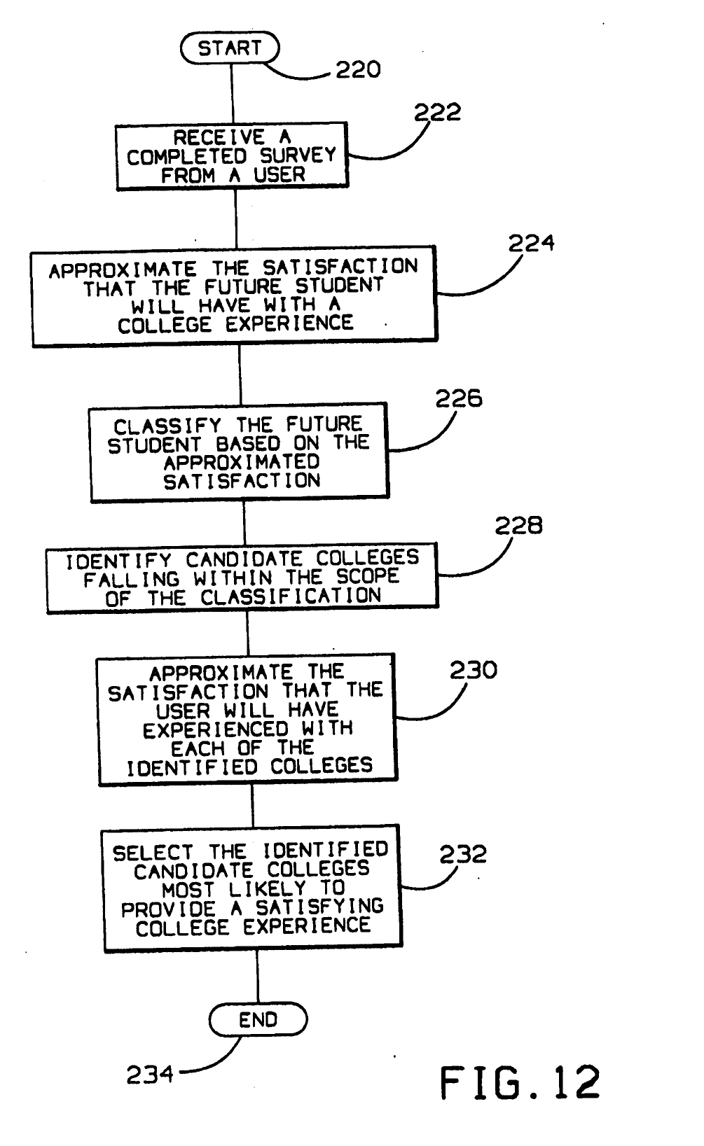

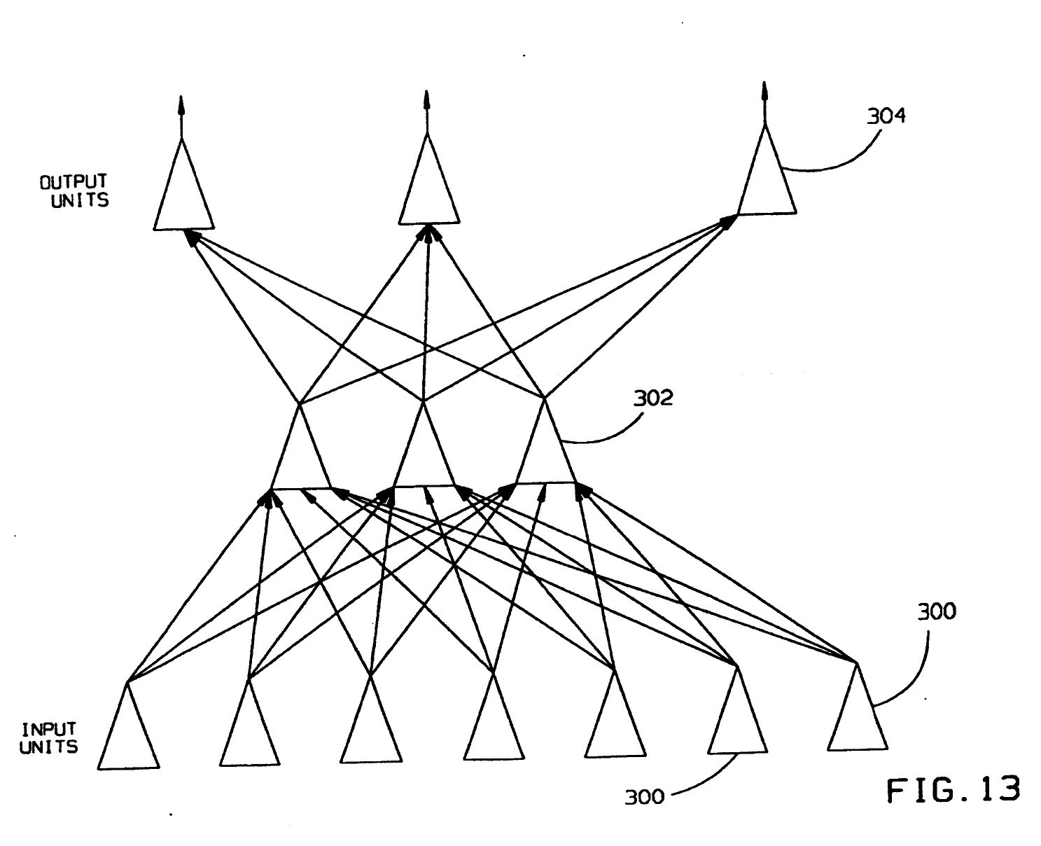

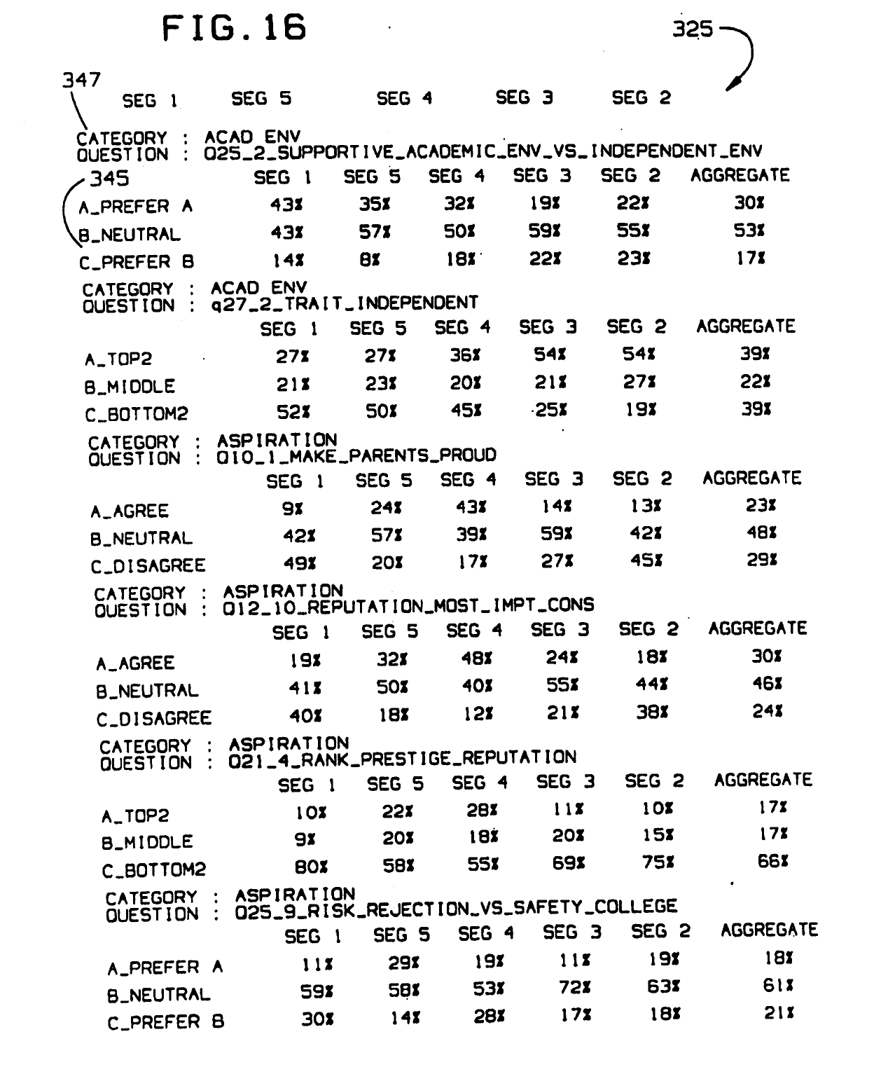

FIG. 10 illustrates an embodiment of a method of operating a selection system 10. The method begins at start block 200. At process block 202, the selection service 14 prepares empirical data. An example of a method for preparing the empirical data is illustrated in FIG. 12. At process block 204, the selection service 14 uses the prepared empirical data to match a student of the selection service 14 with one or more candidate colleges selected from a pool of candidate colleges. An example of a method for matching the prospective student with one or more candidate colleges is illustrated in FIG. 13. At process block 206, the selection service 14 provides the optional communication between the student and the one or more selected candidate colleges. FIG. 16 provides an example of methods of providing communication between the student and the one or more selected candidate colleges. The method terminates at end block 208.

FIG. 11 illustrates an example of a method of preparing empirical data for matching a prospective student with a college candidate. The empirical data can be prepared before each prospective student is to be matched with a college candidate. Alternatively, the empirical data can be prepared periodically. For instance, the prepared empirical data can be used to match several prospective students of the selection service 14 with candidate colleges and then the empirical data can be prepared again. The method of preparing the empirical data begins at start block 210. The method is preferably started in response to a student using a remote unit 16 to access the selection service 14, completing a survey 20 and requesting a list of appropriate candidate colleges. Alternatively, the preparation of empirical data can be started in response to particular criteria such as passage of a particular amount of time or a particular number of prospective students having been matched. At process block 212 the empirical database 24 is updated. This database can be updated to include information from a completed survey 20 submitted by a prospective student who is requesting a list of potential matches. Updating the database can also include removal of information from the database. For instance, outdated information can be extracted. Other databases can be updated at this stage. For instance, data for generating an individual student satisfaction index for each member of a PSCC that was matched by the selection service can be incorporated into the databases. The resulting individual student satisfaction index can be listed in the factor value database.

At process block 214, the updated empirical database 24 is used to generate an individual student satisfaction estimator. At process block 216, the updated empirical database 24 is used to generate a PSCC satisfaction estimator. The method terminates at end block 218.

FIG. 12 illustrates a method of matching a student of the system 10 with one or more candidate colleges. The method starts at start block 220 when a prospective student completes a survey 20 and requests a list of appropriate candidate colleges to consider attending. At process block 222 the completed survey 20 is received from the student. The prospective student preferably employs a remote unit 16 to transmit the survey 20 to the selection service 14 although the survey 20 can be mailed or completed in person at the selection service 14.

At process block 224, the satisfaction that the prospective student may have in an unspecified college is approximated. This approximation can be made by determining an approximate prospective student satisfaction index for the prospective student. One method for determining the approximate prospective student satisfaction index includes identifying the category to which the student belongs. The individual satisfaction estimator associated with the identified match group is then identified. The student's answers to at least a portion of the inquiries 22 on the survey 20 are compared to the identified prospective student satisfaction estimator. In one embodiment, comparing the student's answers to the identified student satisfaction estimator includes calculating the value of the selected factors from the answers that the prospective student provided and then comparing the calculated factors to the student satisfaction estimator. At process block 226, the approximate student satisfaction index is used to classify the prospective student.

At process block 228, the candidate colleges that have actual student satisfaction which fall within the same or similar classification as of the prospective student are identified. At process block 230, the satisfaction that the prospective student would have in a relationship with each of the identified candidate colleges is approximated. This approximation can be made by determining an approximate PSCC satisfaction index for the student and a candidate college. One method for determining the approximate PSCC satisfaction index includes comparing at least a portion of the answers provided by the prospective student and the aggregate answers for the candidate college to the PSCC satisfaction estimator. In one embodiment, comparing the answers provided by the student and the candidate college to the PSCC satisfaction estimator includes calculating the selected differential factors from the answers provided by the prospective student and a the aggregate of student responses to the candidate college and comparing the selected differential factors to the PSCC satisfaction estimator.

At process block 232, the approximated satisfaction that the student would have in attending each of the identified candidate colleges are used to select the candidates for identification and recommendation to the prospective student. The method then terminates at end block 234.

Optionally, the methods described above with respect to the data preparation stage and/or the candidate identification stage can be used to train a neural network. The neural network can be trained to receive data from a student's survey and to output a list of appropriate candidate colleges. A suitable neural network includes, but is not limited to, a principal component analysis (PCA) neural network that includes a mixture of unsupervised and supervised. The unsupervised segment of the network can perform the factor analysis. A PCA neural network converges very rapidly and there are usually fewer factors extracted than there are inputs, so the unsupervised segment provides a means of data reduction.

A simplified example of a supervised backpropogated neural network is illustrated in FIG. 13. The supervised backpropogated neural network includes a plurality of input units 300 that are each in communication with a hidden unit 302. Each hidden unit 302 is in communication with an output unit 304. Although a single layer of hidden units 302 is illustrated, the backpropogated neural network can include more than one layer of hidden units 302. The supervised backpropogated neural network can be trained to randomly determine parameter values and carry out input-to-output transformations for identifying matching candidates for a prospective student.

The PCA data is applied to train the backpropagated neural network. In the supervised segment, the network performs the (linear or nonlinear) classification of the factors using a back propagation architecture that can randomly determine parameter values and carry out input-to-output transformations for actual problems. The correct final parameters are obtained by properly modifying the parameters in accordance with the errors that the network identifies in the process. The use of back propagation can include a delta rule network in which the one or more layers of hidden units 302 are added. The network topology can be constrained to be feed forward. For instance, the connections can be allowed from the input layer to the first hidden layer and from the first hidden layer to any subsequent hidden layers and then to the output layer. Multiple hidden layers can learn to recode the inputs to achieve the best estimation of output units 304.

The neural network can also include a Kohonen neural network so it can adapt in response to the inputs. The use of a Kohonen neural network allows for self-organizational mapping and competitive learning. In self-organizational mapping, the Kohonen neural network allows for the projection of multidimensional points onto two dimensional networks. In competitive learning, the Kohonen neural network finds a pattern of relationships that is most similar to the input pattern. This results in a Kohonen clustering algorithm that takes a high dimensional input and clusters it but retains some topological ordering of the output. This clustering and dimensionality reduction is very useful as a further processing stage in which further neural networking data processing can be accomplished and the identification of good prospective student college candidates matches optimized.

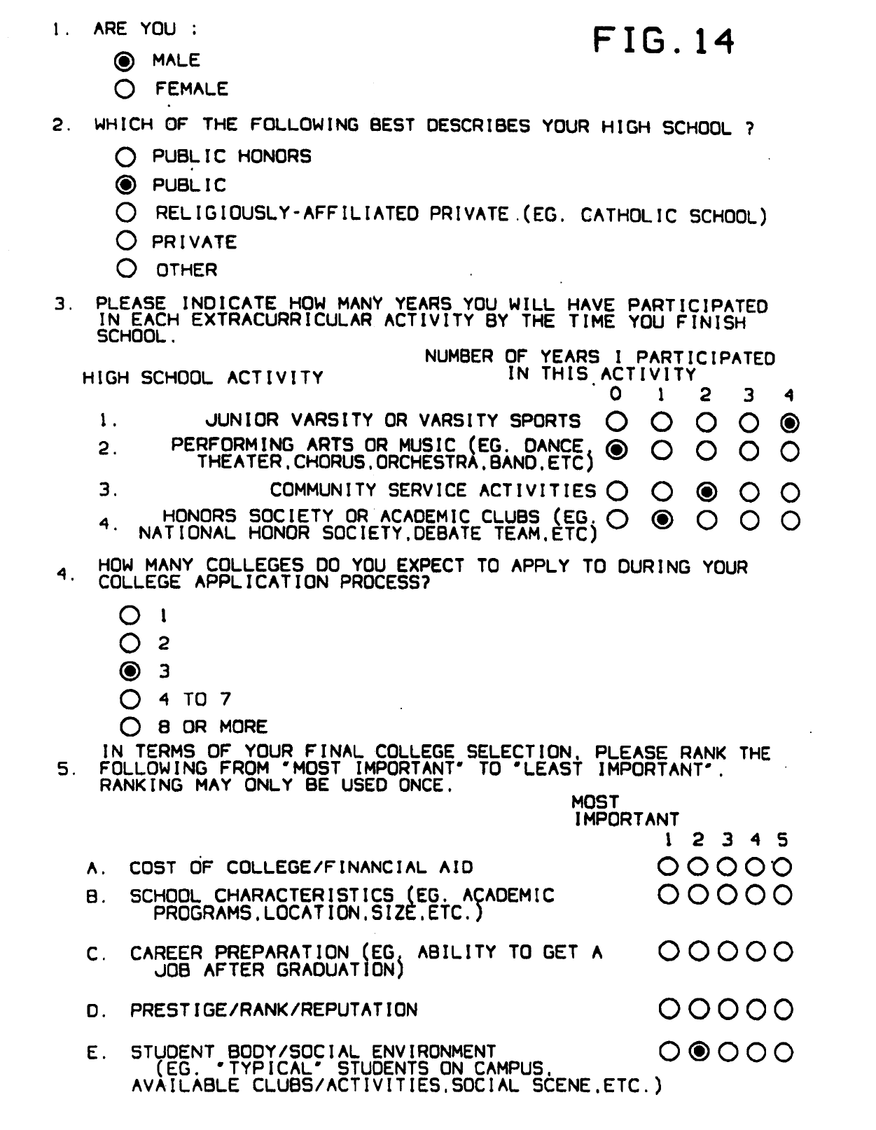

Another preferred embodiment of the method of the invention is illustrated in FIGS. 14-21. The selection method 312 of FIGS. 14-21 may utilize the same system hardware 10 for a prospective student to select one or more appropriate college candidates as described above with reference to FIGS. 1-13 including one or more remote units 16. In this preferred embodiment, a conventional single processor computer is preferred due to the lower computational requirements of this method, rather than the neural network described immediately above.

A prospective student of a remote unit 16 and the selection service 314 can communicate as shown by the arrow labeled A. The preferred communications includes the use of real-time interactive web pages. The prospective college student of the remote unit 16a can also communicate with the candidate college remote unit 16b as indicated by the arrow labeled B. The selection service provides the communication by receiving the communication from the prospective student and providing the communication to the candidate college.

The selection service 314 generally employs an actual student data segmentation stage, a prospective student survey data receiving stage, a student segmenting stage, and a candidate colleges identifying stage. During the actual student data segmentation stage, empirical data is gathered and the analyzed in preparation for the prospective student segmenting stage. The empirical data is also used to assist in identifying one or more candidate colleges for the prospective college student in the selection stage.

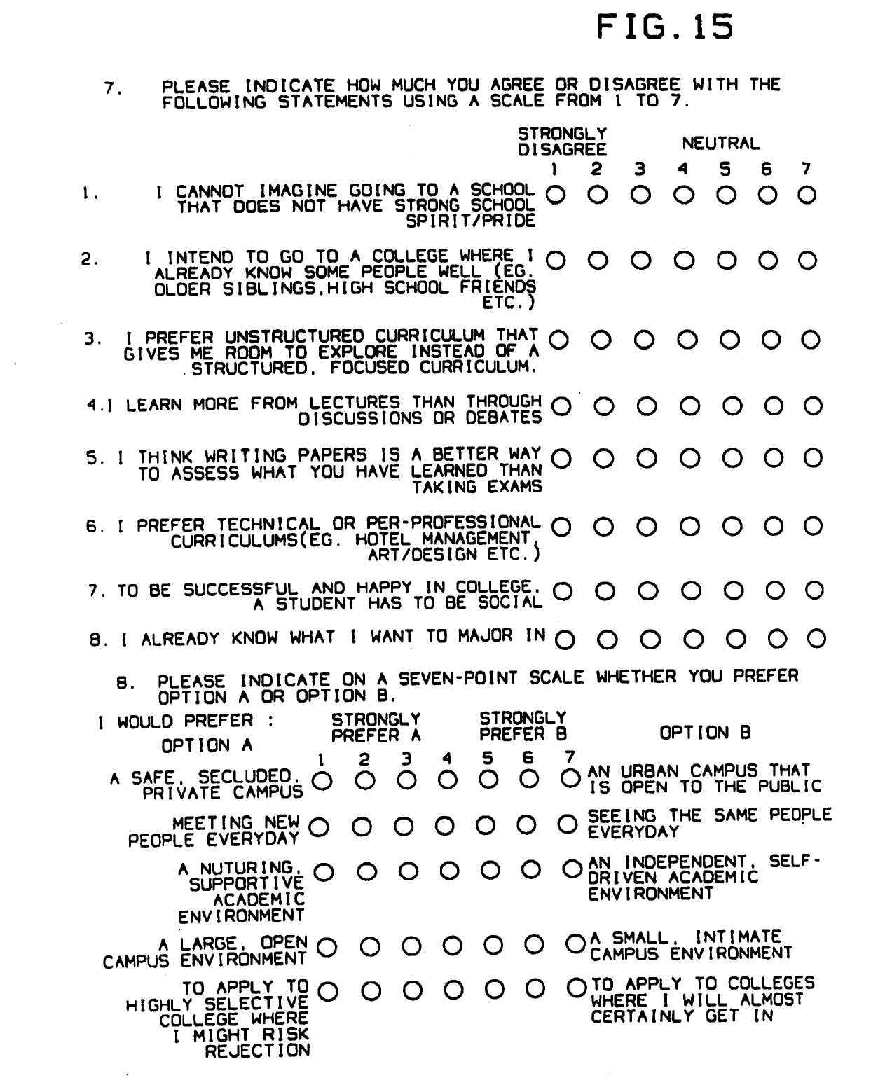

During the data segmentation stage, the selection service 314 employs empirical data which is generated from answers to a survey such as are exemplified with the survey questions 322 illustrated in FIGS. 14-15. The survey 320 asks a series of inquiries 322 some of which can be numerically answered. The prospective student provides an answer somewhere along the scale based on their preference for the activity. For instance, a “1” can indicate that the student has no budgetary constraints, while a “7” indicates that the student has serious budget constraints. Because the answer to each question varies from prospective student to prospective student, each inquiry and the associated answers are often referred to herein as variables.

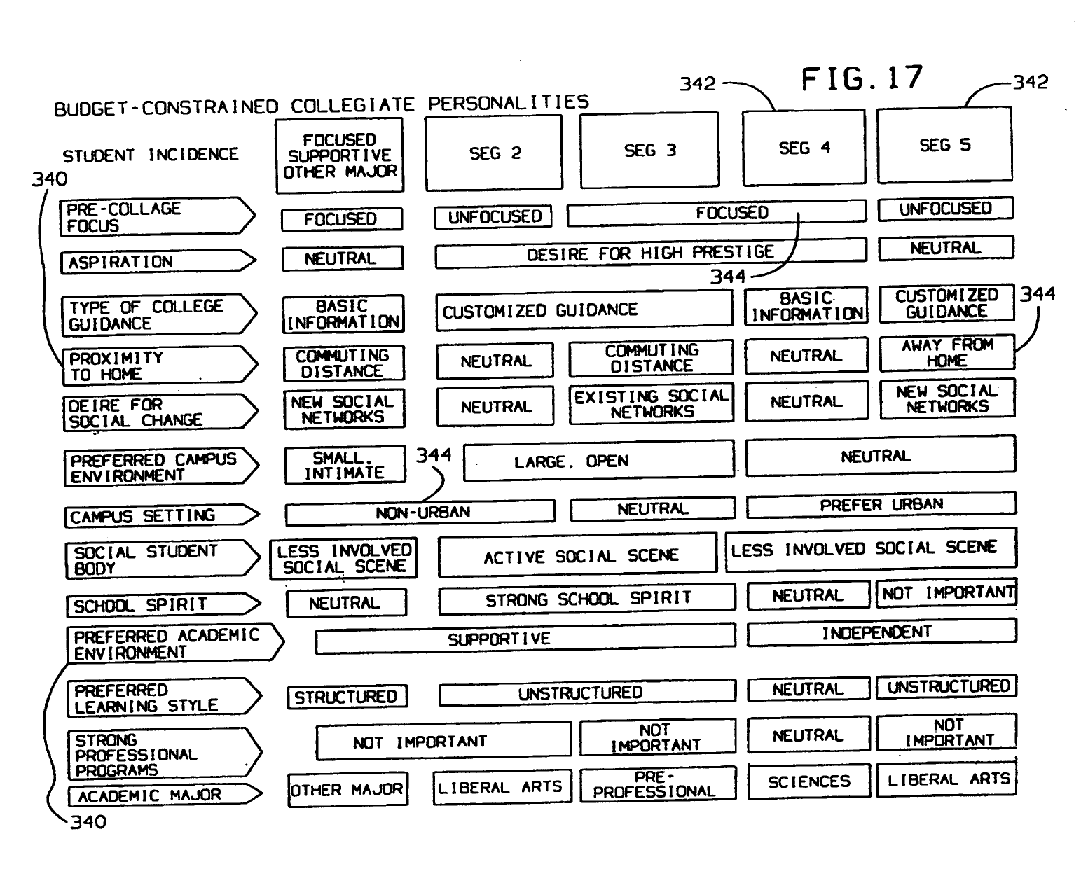

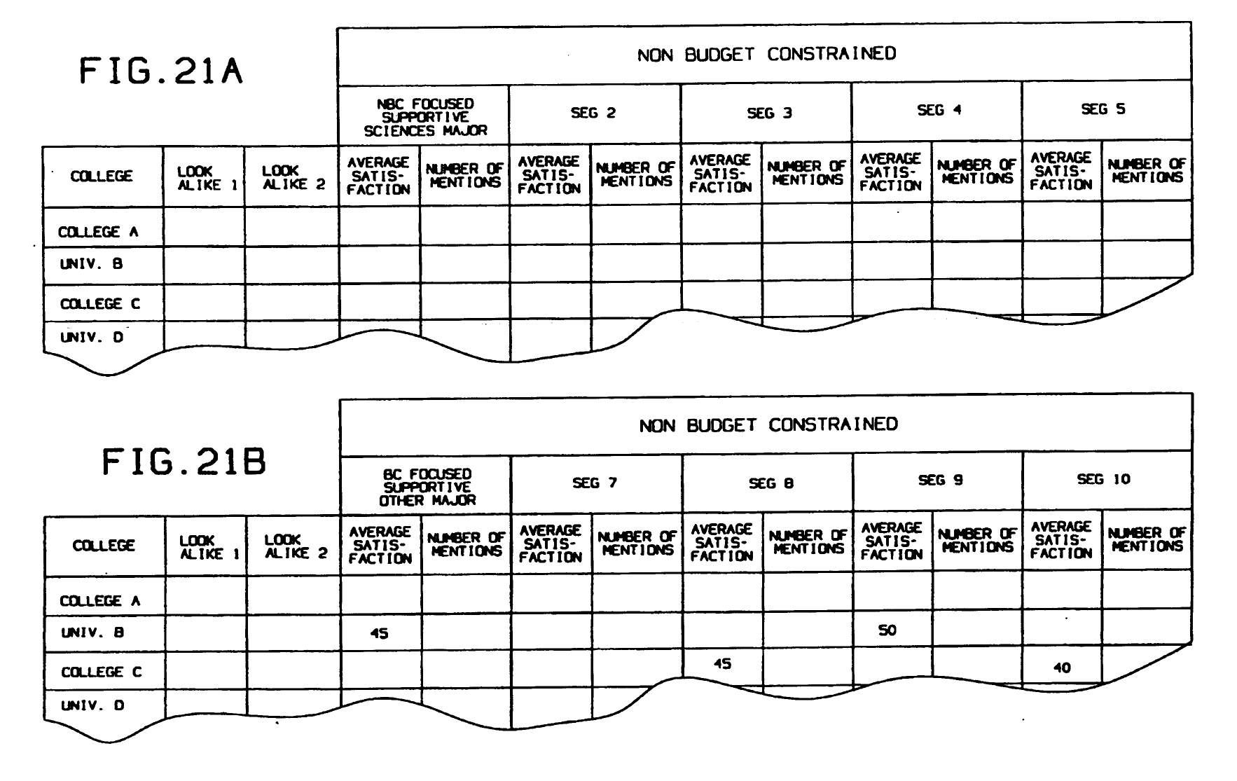

Surveys, such as 320, can be completed by actual college students for the purpose of generating enough data for the selection service to make reliable selections of candidate colleges for prospective students. The applicant commissioned empirical research among a representative sample of 2000 college sophomores and junior (upon completion of those school years) to identify key variables that drive college student satisfaction and to construct college personalities segmentation solution for United States college students reflecting budget constraints (or lack thereof), other internal motivators, environmental motivators and academic motivators. The survey results were stored in a database 325 as sample page of the print out of the database and segment analysis to determine projected collegiate personality segments is shown in FIG. 16. The left column heading 345 breaks the data down into three categories per query type, e.g., prefer A, middle, middle/neutral, prefer B. The results for each question are as a percentage of each segment. An iterative, modes-based clustering process was applied to develop the optional clustering solution based upon a comprehensive set of college satisfaction drivers. The clustering technique maximizes homogeneity within each segment while maximizes heterogeneity between segments. As illustrated in FIG. 16 some heterogeneity remains within each resulting segment. Similar empirical surveys were administered to 16,000 additional college sophomores and juniors. FIG. 17 exemplifies the analyzed data and its correlation with the segmented data within student collegiate personality segment analysis database 326. The projected collegiate personality segments were applied onto the data from the group of 16,000 college students, and the scored students were segmented into discrete collegiate personality segments. This data from the additional students correlated well with the projected college personalities. This data was then analyzed to yield a comprehensive student collegiate personality/college match database 330 as shown in FIG. 21 containing data from 18,000 students with each student scored into collegiate personality which best describes each student's drivers of college satisfaction and each student matched to the college which yielded satisfaction. The preferred program for generating the segments database 325, 326 and collegiate personality/college match database 330 is the Segment-Based Marketing System from Rosetta Marketing Strategies Group of Princeton, N.J. This segmenting system and method program is described in detail in U.S. Pat. No. 6,745,184 assigned to Rosetta.

For prospective students, the survey 320 is preferably completed by means of a remote unit 16 with access to interactive web pages provided by the selection service 314. The survey can be made available to the prospective student in the form of one or more interactive web pages after the prospective student has registered for use of the selection service. After submitting the completed survey to the selection service, the prospective student can request a list of candidate colleges from the selection service. The prospective student can also request to become a candidate to receive information concerning additional non-selected colleges.

The survey and/or the registration process can also request information to further categorize the prospective student to assist in the candidate college selection process. For instance, prospective student seeking candidate colleges having a specific religious affiliation, location, tuition range or academic requirements that are easily categorized and thereby limited the scope of the search. The survey 320 need not be constant and can change with time. For instance, as the selection service 314 finds that certain inquiries are less effective at revealing college experience satisfaction; these inquiries can be dropped from the survey 320. Additionally, the selection service can add new questions to the survey to find out whether the new questions add insight into college experience satisfaction. Generally, it is preferred that the collegiate personality survey should include questions that are directed to determining at least the following: the degree of the student certainty regarding intended college major, the degree of student certainty regarding colleges to apply to, the importance of college prestige, the desire to meet new people, preference for a large/small campus, any preference for active/inactive social scene, preference for strong/weak school spirit, degree of independence and self motivation academically, and preference for structured/unstructured learning environment.

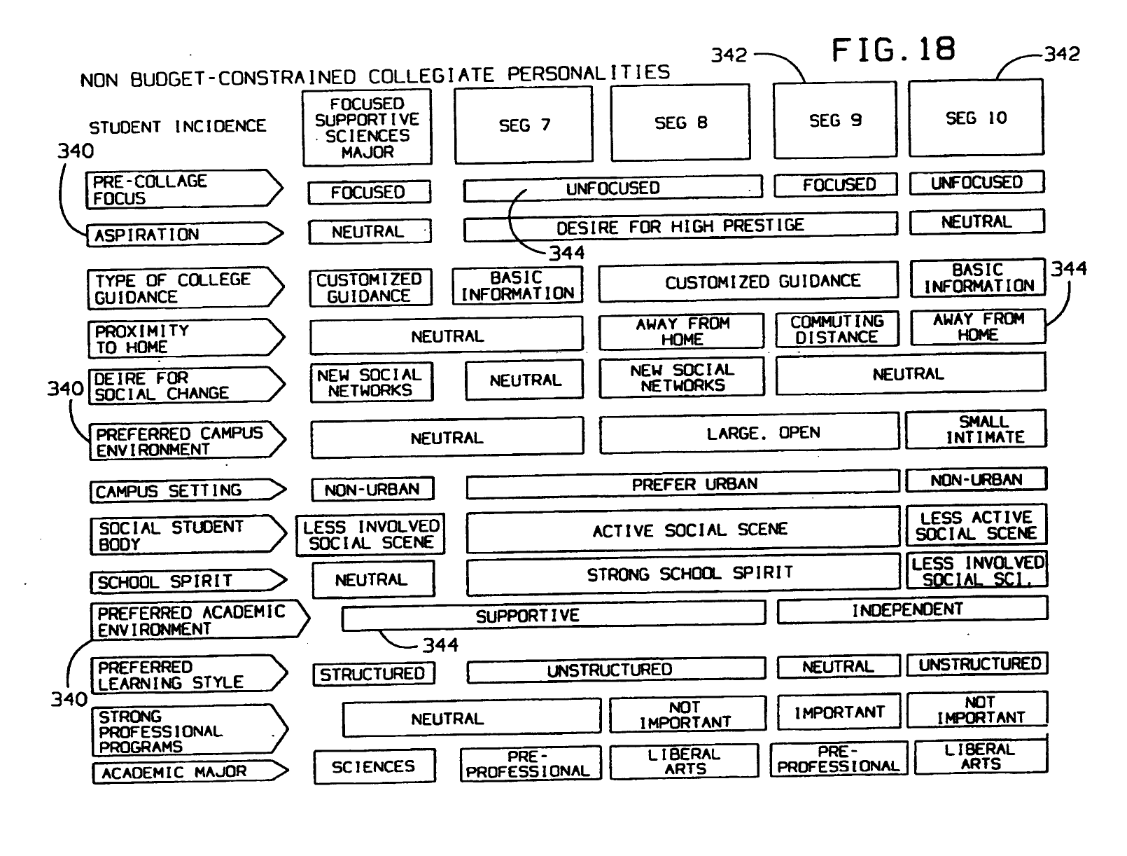

For each collegiate personality, a comprehensive qualitative profile is developed based upon the empirical data of the thousands of students scored into each collegiate personality. For example, one complete qualitative segment description follows. It is written in the segmented students own words for the “Non Budget Constrained Focused Supportive Sciences Major Segment.”
I have a good idea of my intended major and the schools I would like to go to. I may apply early decision to one particular college and will likely apply to no more than 3 colleges in total. However I would still appreciate having more guidance during my college application process such as a customized list of recommended colleges.
I am less budget-constrained, thus the two most important factors for me in my final college selection process are the school characteristics (e.g. academic programs, location, size) and its career preparation programs. I am less concerned with the prestige or reputation of the school and its proximity to my hometown. An urban campus location is less important to me.
I tend to major in the math, science or engineering fields. I am generally focused, and tend not to change my major once I have decided on it. I am also more likely to take my religious faith seriously.
I prefer a supportive academic environment with more structure in the curriculum and the in the classroom. Small class sizes and special academic programs are not critical to me.
I am looking to expand my social networks and meet new people, and thus I am comfortable attending a college where I do not know anyone. However I am not necessarily seeking a wild campus social scene with lots of parties. I would characterize a successful student at my ideal college as someone who is ambitious, intellectual and slightly more conservative with strong moral values.
   The other preferred segments may be given any of a number of appropriate descriptive titles, e.g., BC-Focused Supportive Other Major. FIGS. 17 and 18 are schematic representations of the variables considered in the segmentation process and their correlation or lack thereof with the assigned segments. The description 340 of the considered variable is listed in the far left column. The heading 342 of the right hand columns lists the segment. The right hand columns themselves illustrate the presence, absence or neutrality 344 of each variable correlated with the segment.

The collegiate personality segments are next further segmented by taking into account the pre-college academic achievements of the actual students in the database. At this point, the actual college student data is fully segmented into a mutually exclusive collectively exhaustive (MECE) segment that account for budget constraints, collegiate personality, and academic achievement. Each of the segments is then matched with a group of colleges that yielded high degrees of satisfaction for each of the segments into a collegiate personality-academic achievement/college match database 330 which contains a college recommendation set for each segment as shown in FIGS. 21 A and 21B. The database 330 and recommendation sets can be generated in a variety of different ways which will be described immediately below. In one preferred method, the database 330 is generated by utilizing the qualitative summaries of the empirical data to provide one or more expert college counselors with defined segments to match with appropriate candidate colleges. The expert(s) base each match for each collegiate personality/college personality upon their research and experience concerning the college environment at each candidate school. Optionally, the resultant collegiate personality/candidate recommendation sets chosen by the college counselors can be compared to the empirical actual college satisfaction data to provide an empirical check on the contents of the each recommendation set in the database 330 to ensure that appropriate colleges were included or inappropriate candidate colleges excluded.

In another alternate method of generating the database 330 and college recommendation sets, each of the actual student collegiate personality-academic achievement segments are matched with candidate colleges with high student satisfaction scores for a given segment. This can be done by searching the actual college student satisfaction data for the best fit with each of the actual student collegiate personality-academic achievement segments. Preferably, the database of matching colleges and college personalities is reviewed by experts in college placement to ensure that the correlations from the database are consistent with the expert's real world experience. Any correlations between collegiate personality profile and college satisfaction which the expert feels is tenuous or erroneous should be removed the database. This expert clean up function is preferred since it can weed out the effects of “terminally satisfied students,” that is, those students that have no strong preference concerning common satisfaction drivers. Such students appear to be happy at any college, and thus, their college data is not helpful in identifying college satisfaction drivers and assigning students to their best fit colleges. The expert clean up function ensures that the final college recommendation sets for the prospective student is not overly inclusive due to the effect of data from “terminally satisfied students.”

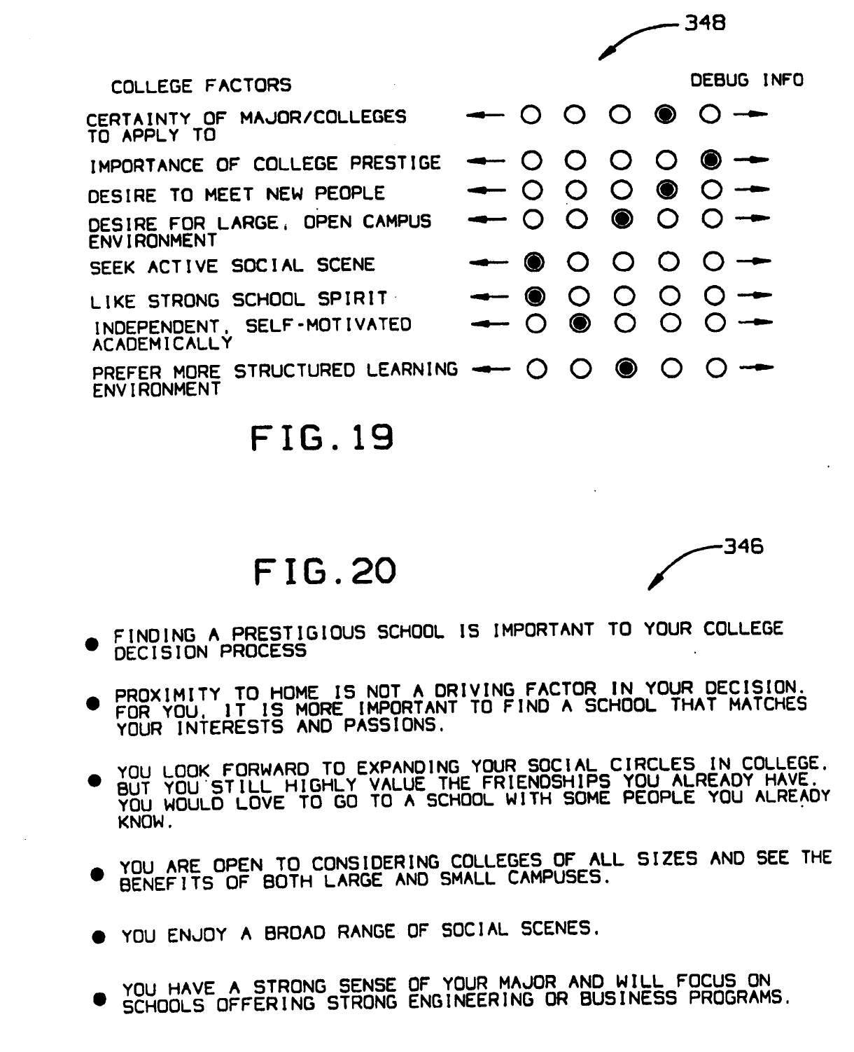

When a prospective student fills out his or her survey and is about to be segmented, it is preferred that a written personality description 346 is displayed to the prospective student in real time. An example of such a description is shown in FIG. 20. Optionally, a summary of collegiate personality factors 348 can also be shown graphically to the college student as shown in FIG. 19. The purpose of these displays is to ensure that the student generally agrees with the answers for important segmentation variables which will be used by a scoring tool to segment the prospective student. The student can also be asked to review survey answers he or she gave to correct any erroneous answers that may lead to a less than satisfactory personality description.

Once the student confirms that the segmentation data is appropriate, a scoring tool can be used to segment the prospective college student into one of a plurality of appropriate student collegiate personalities based on the survey data. The scoring tool is designed to translate survey data provided by prospective college students into prediction of the collegiate personality segment which best reflect the college satisfaction drivers of that prospective college student. The collegiate personality scoring tool survey may also take into consideration the data derived from additional survey questions designed to capture all other relevant college selection drivers for each prospective college student. These other college selection drivers enable the system to further refine the collegiate personality recommendation set derived from the a collegiate personality-academic achievement/college match database 330 into customized college recommendation for each prospective student user.

One such additional question is to query the prospective college student as to geographical preferences for colleges. Another is to investigate a student's desire to consider only religious colleges. Assuming the prospective student has such a preference, the college recommendation set can be further limited by removing from the candidate college list any candidate colleges which falls outside the prospective student's selected geographical, religious or other stated preferences. In any event, the college recommendation set is displayed to the prospective student, preferably, in real time.

It is also contemplated that the methods and systems of the invention may be used for prospective students considering other types of schools for which there are a large number of potential choices. For example, survey data may be gathered for actual students of post secondary vocational schools such at culinary academies, technical colleges (schools), nursing schools or medical technician schools. Similarly, the system and methods of the invention is used by prospective students of post graduate education (masters degree, doctorate, etc.) or professional schools such as law schools, medical schools, dental schools, etc. Such schools are collectively defined for purposes of this application as “post secondary schools.” In such systems and methods, actual student preference data is collected for students attending a plurality of one classification of a post secondary school, e.g., all technical vocational schools. The data would then be segmented into a plurality of post secondary school personality profiles for that classification of school. Where appropriate to a category of post secondary school (some vocational schools do not consider past academic performance for admission), the actual student data is further segmented by past academic achievement. Then, the personality profile is matched to the appropriate groups of schools based on the actual student preference data for each segment. In a manner similar to that described above, candidate school recommendation sets are developed for each prospective student user. Survey data is generated for a prospective student of the classification of post secondary school, and the student is segmented into the appropriate personality profile. The appropriate post secondary schools are identified by matching the student's personality profile with the post secondary recommendation set for actual students falling within the same segment. Of course, optionally, the recommendation set may be further narrowed as described above by utilizing college selection drivers for the prospective student such as geographic location preferences, etc.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

The invention, embodied as a system and method, generally include predicting the satisfaction that a prospective college student of the service may have in a college experience by referencing empirical data of actual student's college satisfaction at a number of colleges, and identifying candidate schools for the student based on the predicted satisfaction.

What is claimed:

1. A method to be performed by a computer for selecting appropriate candidate colleges for a prospective college student to consider attending, comprising:
receiving survey data gathered from a prospective college student;
analyzing the survey data for relationships between one or more variables which correlate with actual college student satisfaction with their college experience; and
identifying, with the computer, one or more candidate colleges for the prospective college student to consider by determining an association between the prospective college student's survey data and one or more of the variables which correlate with actual college student satisfaction with their college experience.

2. The method of claim 1, wherein the method includes the additional step of approximating the satisfaction that the prospective college student will have in attending at least one particular candidate college from the association between the prospective college student's survey data and one or more of the variables which correlate with actual college student satisfaction with their college experience.

3. The method of claim 2, wherein the step of analyzing the survey data includes generating an approximate individual satisfaction score for the prospective college student.

4. The method of claim 1, wherein the method includes the additional step of creating a plurality of mutually exclusive collectively exhaustive student segments which highly correlated with actual student satisfaction with particular sets of colleges.

5. The method of claim 3, wherein the step of analyzing the survey data includes the step of segmenting the prospective college student into one of the plurality of mutually exclusive collectively exhaustive student segments.

6. The method of claim 5, wherein the step of analyzing the survey data includes generating an approximate prospective student satisfaction score and the step of identifying one or more candidate colleges further includes the step of matching the prospective student satisfaction score with empirical satisfaction scores of students attending a candidate college.

7. The method of claim 1, wherein the step of analyzing the survey data includes generating a prospective student satisfaction estimator.

8. The method of claim 3, wherein the individual satisfaction estimator includes a relationship between an individual satisfaction index and one or more survey questions answered by the prospective student.

9. The method of claim 3, further comprising: receiving a survey from the prospective student, the prospective student having provided answers to a plurality of inquiries in the survey, at least a portion of the answers being associated with a number; and comparing answers provided by the prospective student to an aggregate of actual student satisfaction for a candidate college.

10. The method of claim 9, wherein the step of analyzing the survey data includes the step of classifying the prospective student based on scoring the answers provided by the prospective college student; and the step of identifying one or more candidate colleges includes comparing actual student aggregate survey answers for a particular candidate college with survey answer scores of the prospective student.

11. The method of claim 10, wherein the step of analyzing the survey includes generating an approximate prospective student/candidate college satisfaction index for the attendance of the prospective student at the particular candidate college.

12. The method of claim 1, wherein the step of analyzing the survey data includes generating a prospective student/candidate college satisfaction estimator.

13. The method of claim 12, wherein the prospective student/candidate college satisfaction estimator includes a relationship between an actual student satisfaction index calculated from survey answers and one or more survey questions answered by the prospective student.

14. The method of claim 1, further comprising: receiving survey data from the prospective student including answers to a plurality of inquiries of the survey at least a portion of the answers being associated with a number; and further including the step of selecting a candidate college to be matched with the prospective student, the candidate colleges having actual student who have provided answers to a second survey, at least a portion of the answers provided by the actual students being associated with a number; and comparing at least a portion of the answers provided by the prospective student and at least a portion of the answers provided by the actual students of the candidate college to provide a satisfaction estimator for the candidate college.

15. A method to be performed by a computer for operating a selection service, comprising:
receiving a plurality of surveys completed by actual students of candidate colleges, each survey including a plurality of inquiries into matters which are relevant to each actual student having a satisfying experience with a particular candidate college, at least a portion of the inquiries having answers that are associated with a number;
performing a factor analysis on the answers to the inquiries to identify a plurality of factors, each factor corresponding to a function of one or more variables representing the inquiries;
generating a satisfaction index from the factor analysis that approximates the satisfaction that a prospective student is expected to have in attending a candidate college;
receiving a survey completed by prospective students of candidate colleges including a plurality of inquiries into matters which are relevant to the prospective student having a satisfying experience with a particular candidate college; and
matching the prospective student to a candidate college based upon the satisfaction index and based upon differences between the value of at least one factor for the prospective student and the value of at least one factor for actual students attending a candidate college.

16. The method of claim 15, wherein the factor analysis is a principal component analysis.

17. The method of claim 15, further comprising: selecting the factors that most highly predict satisfaction in a prospective student's satisfaction with a college experience.

18. The method of claim 15, wherein selecting the factors includes performing a linear regression on the factors and the satisfaction index.

19. The method of claim 15, wherein selecting the factors includes performing a correlation analysis on the factors and the satisfaction index.

20. An automated system for operating a prospective college student college selection service, comprising:
means for generating, from empirical data, a number of factors corresponding to a like number of functions of one or more variables relevant to satisfaction with college experience;
means for approximating the satisfaction that a prospective student of the college selection service will have in attending a college; and
a computer for identifying candidate colleges for a prospective student to consider attending by determining an association between the approximated satisfaction and one or more of the factors.

21. A method to be performed by a computer for selecting appropriate candidate colleges for a prospective college student to consider attending, comprising:
receiving survey data concerning college satisfaction motivators for the prospective college student;
segmenting, with the computer based upon the survey data, the prospective college student into a collegiate personality segment which correlates with empirical satisfaction data approximating actual college student satisfaction; and
identifying one or more candidate colleges for the prospective college student based on the collegiate personality segment of the prospective college student.

22. The method of claim 21 wherein the step of identifying one or more candidate colleges includes matching the collegiate personality segment of the prospective college student with a defined candidate college recommendation list.

23. The method of claim 22 wherein the step of identifying one or more candidate colleges includes generating the defined candidate college recommendation list by having a college placement professional study the at least one of the plurality of collegiate personality segments and match candidate colleges for the inclusion in the defined candidate college recommendation list based on the professional's judgment.

24. The method of claim 22 wherein the step of identifying one or more candidate colleges includes generating the defined candidate college recommendation list by correlating the empirical satisfaction data of actual college students of a collegiate personality segment with candidate colleges yielding the highest satisfaction data for the prospective student's collegiate personality segment.

25. The method of claim 21, wherein the step of segmenting the prospective student includes macro-segmenting the prospective student into either a budget constrained or a non-budget constrained segment.

26. The method of claim 21, wherein the step of segmenting the prospective student includes further segmenting by means of a collegiate personality scoring tool which assigns a collegiate personality to the prospective student based on a best fit between the prospective student's college satisfaction motivator data and defined collegiate personality segments based on empirical college satisfaction data.

27. The method of claim 25, wherein the step of segmenting the prospective student includes further segmenting the prospective student based on the student's academic achievement.

28. The method of claim 21, wherein the step of identifying one or more candidate colleges includes retrieving a candidate college list in which the prospective student's collegiate personality/academic achievement segment has been matched with a list of appropriate candidate colleges.

29. The method of claim 27, wherein the list of candidate colleges has been generated by searching a database for the best fit between the collegiate personality/academic achievement segment and the empirical actual college satisfaction data for a plurality of colleges.

30. The method of claim 27, wherein the step of generating the list of candidate colleges includes removing one or more inappropriate candidate colleges from the candidate college list based on input from a college placement professional's expertise.

31. The method of claim 30, wherein the step of identifying one or more candidate colleges includes removing from the candidate college list one or more candidate colleges which fall outside the prospective student's selected geographical preferences.

32. The method of claim 21 which further includes the step of determining an approximated college satisfaction score for the prospective college student for one or more of the candidate colleges on the candidate college list.

33. The method of claim 21 which includes the further the step of determining an approximated college admission probability score for one or more of the candidate colleges on the candidate college list based upon the probability of the prospective college student's admission in the candidate college.

34. The method of claim 33, wherein the step of determining an approximated college admission probability includes providing a rank of one more of the candidate colleges as safety, target, or reach.

35. The method of claim 34, wherein the step of determining an approximated college satisfaction score includes comparing the prospective student's academic achievement with the college's historical admission data for similarly academically qualified students.

36. The method of claim 21, wherein the step of segmenting a prospective student includes the step of displaying a written personality description for the prospective college student which provides a qualitative summary of the prospective college student's collegiate personality profile.

37. The method of claim 36, wherein the step of segmenting a prospective student includes the step of querying the prospective college student as the accuracy of the written personality description.

38. The method of claim 37, wherein the step of segmenting a prospective student includes the step of allowing the prospective college student to correct any survey questions that correlate with any inaccuracy in the displayed written personality description.

39. The method of claim 21, wherein the step of segmenting a prospective student includes the step of displaying a written personality description for the prospective college student which provides a qualitative summary of the prospective college student's collegiate personality customized with specific individual survey-based inputs.

40. An automated system for operating a candidate college selection service by a prospective college student, comprising:
means for receiving survey data concerning college satisfaction motivators for the prospective college student;
a computer for segmenting, based upon the survey data, the prospective college student into a collegiate personality segment which correlates with empirical satisfaction data approximating actual college student satisfaction; and
a computer database for storing the identity of one or more candidate colleges for the prospective college student which positively correlate with the collegiate personality segment of the prospective college student.

41. The automated system of claim 40 wherein the means for receiving survey data includes a real time communication link between the prospective college student and the computer.

42. The automated system of claim 40 wherein the automated system further includes a display means for provide the identity of the one or more candidate colleges to the prospective college student.

43. The automated system of claim 41 wherein the real time communication link includes real time student data input means for real time correction of erroneous survey data.

44. A method for generating a collegiate personality segment candidate college for use in operating a college selection service, comprising:
receiving survey data from actual students of candidate colleges, each survey including a plurality of inquiries into matters which are relevant to each actual student's satisfaction with a particular candidate college;
segmenting, with a computer, the actual students into a plurality of college personality segments based upon an analysis of the correlation between the survey data and the actual college student's satisfaction with their college experience; and
creating for at least one of the plurality of collegiate personality segments a collegiate personality/candidate college recommendation list by matching the at least one of the plurality of personality segments with a group of appropriate candidate colleges.

45. The method of claim 44, wherein the step of creating a collegiate personality/candidate college recommendation list includes the step of a college placement professional studying the at least one of the plurality of collegiate personality segments and matching candidate colleges for the inclusion therein based on the college placement professional's judgment.

46. The method of claim 44, wherein the step of creating a collegiate personality/candidate college recommendation list includes the step of matching the at least one of the plurality of personality segments with a group of appropriate candidate colleges that yield a high degree of actual college satisfaction.

47. The method of claim 46, wherein the step of creating a collegiate personality/candidate college recommendation list includes the step of reviewing the collegiate personality/candidate college database for the inclusion therein of any inappropriate candidate colleges for the at least one of the plurality of collegiate personality segments.

48. The method of claim 47, wherein the step of creating a collegiate personality/candidate college recommendation list includes the step of reviewing the collegiate personality/candidate college database for the inclusion therein of any inappropriate candidate colleges for the at least one of the plurality of collegiate personality segments.

49. The method of claim 48, wherein the step of creating a collegiate personality/candidate college database includes the step of purging from the collegiate personality/candidate college recommendation list any inappropriate candidate colleges to generate a final collegiate personality/candidate college recommendation list.

50. A method to be performed by a computer for selecting an appropriate post secondary school for a prospective post secondary student to consider attending, comprising:
receiving survey data concerning a particular class of post secondary school satisfaction motivators for the prospective post secondary school student of a particular classification;
segmenting, based upon the survey data, the prospective post secondary school student into a personality segment which correlates with empirical satisfaction data approximating actual post secondary school student satisfaction at the particular classification of post secondary school; and
identifying, with the computer, one or more post secondary school of the particular classification for the prospective post secondary school student based on the personality segment of the prospective post secondary school student.
